(19) United States
(12) Patent Application Publication
(10) Pub. No.: US 2025/0293361 A1
(43) Pub. Date: Sep. 18, 2025

(54) FUEL CELL POWER GENERATION MODULE

(71) Applicants: HYUNDAI MOTOR COMPANY, Seoul (KR); Kia Corporation, Seoul (KR)

(72) Inventors: Min Woo KIM, Hwaseong-si (KR); Min Su HYEON, Hwaseong-si (KR); Joon Kyoung KANG, Hwaseong-si (KR)

(73) Assignees: HYUNDAI MOTOR COMPANY, Seoul (KR); Kia Corporation, Seoul (KR)

(21) Appl. No.: 18/954,352

(22) Filed: Nov. 20, 2024

(30) Foreign Application Priority Data
Mar. 12, 2024 (KR) 10-2024-0034564

(51) Int. Cl. H01M 50/204; H01M 50/244; H01M 50/249; H01M 50/291

(52) U.S. Cl. CPC H01M 50/204; H01M 50/244; H01M 50/249; H01M 50/291; H01M 2250/20

(57) ABSTRACT

A fuel cell power generation module includes an accommodation frame defining a first accommodation space, and a first shelf that supports an electric part including a fuel cell, and supported by the accommodation frame to be extracted from the first accommodation space forward thereof.

### CROSS-REFERENCE TO RELATED APPLICATION

The present application claims priority to Korean Patent Application No. 10-2024-0034564, filed on Mar. 12, 2024, the entire contents of which is incorporated herein for all purposes by this reference.

### BACKGROUND OF THE PRESENT DISCLOSURE

### Field of the Present Disclosure

The present disclosure relates to the fuel cell power generation module.

### Description of Related art

Recently, as awareness of the crisis over the environment and depletion of oil resources has increased, research and development on eco-friendly vehicles, such as electric vehicles and fuel cell vehicles have been highlighted.

A fuel cell vehicle is a vehicle that utilizes a fuel cell that generates electricity by reacting hydrogen with oxygen as a power source, and may include a fuel cell stack, and electric parts including a power module complete (PMC) which is an integrated module for generating electrical energy, a balance of plant (BOP), a cooling system, and other filter systems.

As the fuel cell vehicle compactly accommodates the fuel cell stack, the PMC, the BOP, the cooling system, the filter system, and other electric parts, a demand for a fuel cell power generation module that allows easy replacement or repair of the above-mentioned components is increasing.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a fuel cell power generation module that allows extraction of electric parts for replacement or repair of the electric parts while compactly accommodating the electric portions.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a fuel cell power generation module includes an accommodation frame defining a first accommodation space, and a first shelf that supports an electric part including a fuel cell, and supported by the accommodation frame to be extracted from the first accommodation space forward thereof.

The accommodation frame may include rail portions provided on opposite sides of the first accommodation space in a transverse direction of fuel cell power generation module, and the first shelf may include sliding portions coupled to the rail portions, and configured to be slid in a first direction.

The first shelf may include a base frame disposed on a lower side of the sliding portions, and a shelf leg mounted on a front end portion of the base frame to support the front end portion of the base frame.

The base frame may include a leg recess formed on an inside of the base frame, and configured to be opened downward to accommodate the shelf leg, and the shelf leg may be hinged to one side of the base frame to be rotated from the leg recess downward.

A pair of shelf legs may be provided in opposite side portions of the base frame in the transverse direction, and may be configured to be rotated in opposite directions when being rotated from the leg recess downward.

The pair of shelf legs may be hinged to opposite end portions of the base frame in the transverse direction.

The shelf leg may include an upper leg hinged to the base frame, and a lower leg configured to be extracted from an interior of the upper leg.

The shelf leg may further include a fixing member that passes through the upper leg to be inserted into the lower leg, the upper leg may include an external wall accommodating the lower leg in an interior thereof, and a through-hole formed in the external wall and through which the fixing member passes, and the lower leg may include a fixing hole, into which the fixing member is inserted.

The shelf leg may further include a height adjusting leg provided at one end portion of the lower leg, which is extracted from the upper leg, and configured so that a length thereof is adjustable in an second direction.

The lower leg may include a coupling plate formed at the one end portion of the lower leg and including a female screw portion including a height adjusting hole, into which the height adjusting leg is inserted, and the height adjusting leg may include a support portion for being supported by a floor, and a connecting portion extending from the support portion toward the lower leg to be inserted into the height adjusting hole, and including a male screw portion configured to be engaged with the female screw portion.

The first shelf may further include a guide handle mounted on the front end portion of the base frame to be movable in the first direction.

The base frame may include a leg recess formed on an inside of the base frame, and configured to be opened downward to accommodate the shelf leg, and a handle hole formed on an outside of the base frame, and into which the guide handle is inserted.

The shelf leg may include a guide hole formed on an area facing the guide handle when the shelf leg is accommodated in the leg recess, the guide handle may include a fixing portion configured to be inserted into the handle hole and the guide hole, and the fixing portion of the guide handle may be extracted forward from the guide hole when the guide handle is moved forward from the front end portion of the base frame.

The guide handle may further include an elastic member disposed between the fixing portion of the guide handle and the front end portion of the base frame to apply an elastic force to the fixing portion of the guide handle.

The guide handle may further include a through portion connected to the fixing portion of the guide handle, and passing through the handle hole, and the elastic member may extend to surround the through portion.

The accommodation frame further defines a second accommodation space located on an upper side of the first accommodation space, and the fuel cell power generation module may further include a second shelf supported by the accommodation frame to be extracted from the second accommodation space.

The accommodation frame may include rail portions provided on opposite sides of the second accommodation space in a transverse direction of fuel cell power generation module, and the second shelf may include a sliding portion coupled to the rail portions and configured to be slid in a first direction.

The second shelf may include a base frame disposed on a lower side of the sliding portion, and a shelf leg mounted on a front end portion of the base frame to support the base frame, and the shelf leg of the second shelf may include an upper leg hinged to the base frame, a middle leg configured to be extracted from an interior of the upper leg, and a lower leg configured to be extracted from an interior of the middle leg.

The first shelf may include a base frame, and a shelf leg mounted on the front end portion of the base frame to support the base frame, and the shelf leg of the first shelf may include an upper leg hinged to the base frame, and a lower leg configured to be extracted from the interior of the upper leg.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view of a fuel cell power generation module according to an exemplary embodiment of the present disclosure;

FIG. 2 is an exploded perspective view of an accommodation frame, first and second rail portions, and first and second shelves according to an exemplary embodiment of the present disclosure;

FIG. 3 is an enlarged view of a first sliding portion and surrounding components coupled to a first rail portion according to an exemplary embodiment of the present disclosure;

FIG. 4 is a bottom perspective view of a first base frame and surrounding components of a first shelf according to an exemplary embodiment of the present disclosure;

FIG. 5 is an enlarged view of portion “A” of FIG. 4;

FIG. 6 is an enlarged view of a first shelf leg accommodated in a first leg recess, a guide handle for fixing a first shelf leg, and surrounding components according to an exemplary embodiment of the present disclosure;

FIG. 7 is an enlarged view of portion “B” of FIG. 4;

FIG. 8 is a perspective view of a first shelf and a first electric part after a first shelf leg is rotated from a first base frame according to an exemplary embodiment of the present disclosure;

FIG. 9 is a bottom perspective view of a first shelf leg according to an exemplary embodiment of the present disclosure;

FIG. 10A and FIG. 10B are perspective views of a fuel cell power generation module illustrating a first shelf being which is extracted from a first accommodation space and a second shelf which is extracted from a second accommodation space according to an exemplary embodiment of the present disclosure; and

FIG. 11 is a perspective view of a fuel cell power generation module according to another exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the exemplary embodiments of the present disclosure, when it is determined that a detailed description of related known configurations and functions may hinder understanding of the exemplary embodiments of the present disclosure, a detailed description thereof will be omitted.

Furthermore, in describing the components of the exemplary embodiments of the present disclosure, terms, such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms include the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

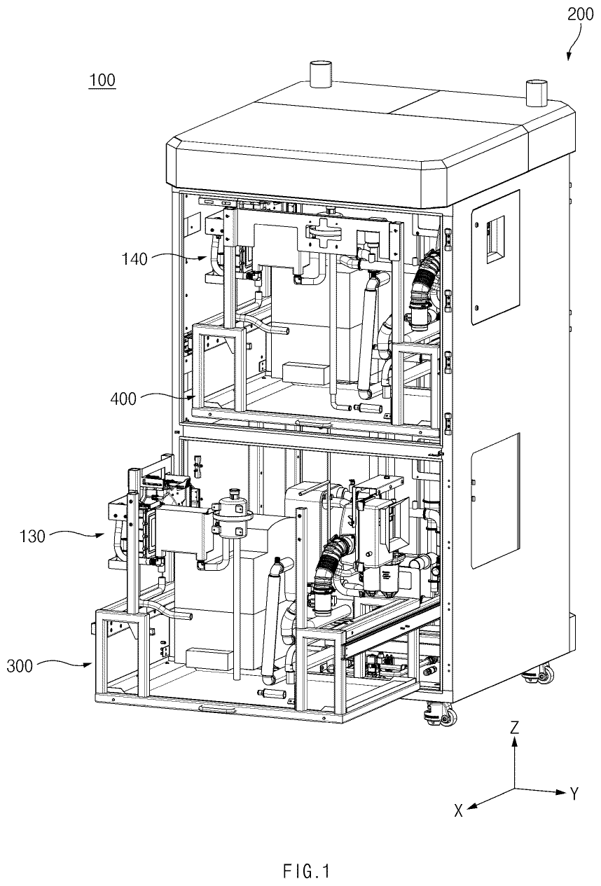

Hereinafter, various exemplary embodiments of the present disclosure will be described in detail with reference to FIGS. 1 to 11.

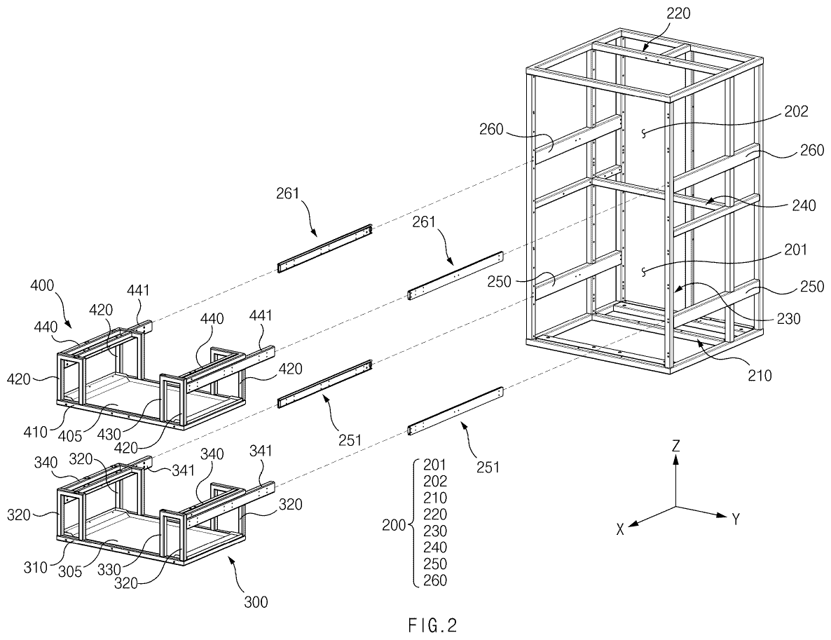

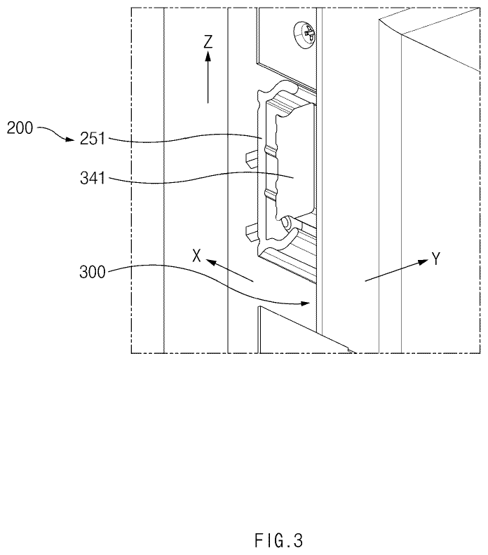

FIG. 1 is a perspective view of a fuel cell power generation module according to an exemplary embodiment of the present disclosure. FIG. 2 is an exploded perspective view of an accommodation frame, first and second rail portions, and first and second shelves according to an exemplary embodiment of the present disclosure. FIG. 3 is an enlarged view of a first sliding portion and surrounding components coupled to the first rail portion according to an exemplary embodiment of the present disclosure.

Referring to FIG. 1, FIG. 2, and FIG. 3, a fuel cell power generation module 100 may be a module which is mounted in an interior of a fuel cell vehicle to provide a power source for the fuel cell vehicle. The fuel cell power generation module 100 may be configured to compactly accommodate electric parts including a fuel cell stack, a PMC, a BOP, a cooling system, a filter system.

The fuel cell power generation module 100 may include an accommodation frame 200 that defines a first accommodation space 201 and a second accommodation space 202, and a first electric part 130 which is accommodated in the first accommodation space 201, and a second electric part 140 which is accommodated in the second accommodation space 202. At least one of the first and second electric parts 130 and 140 may include a fuel cell.

The fuel cell power generation module 100 may include a first shelf 300 which is configured to support the first electric part 130 and a second shelf 400 which is configured to support the second electric part 140. The first shelf 300 may be supported by the accommodation frame 200 to be extracted forward (the “X” direction) from the first accommodation space 201, and the second shelf 400 may be supported by the accommodation frame 200 to be extracted forward from the second accommodation space 202.

In the case of a structure, in which the first and second shelves 300 and 400 may be extracted from the first and second accommodation spaces 201 and 202, it may be relatively easy to repair or replace the first electric part 130 and the second electric part 140, compared to a structure, in which the first and second electric parts are fixed in a position without being extracted from interiors of the first and second accommodation spaces.

The first accommodation space 201 and the second accommodation space 202 may be spaced apart from each other in an upward/downward direction (the “Z” direction or an opposite direction to the “Z” direction). The second accommodation space 202 may be disposed in the upward direction (the “Z” direction) with respect to the first accommodation space 201.

The accommodation frame 200 includes a lower frame 210 which is disposed on a lower side of the first accommodation space 201, and an upper frame 220 which is disposed on an upper side of the second accommodation space 202. The accommodation frame 200 may include a plurality of side frames 230 that extend in the upward/downward direction to connect four corners of the lower frame 210 and the upper frame 220, and a division frame 240 that extends in a leftward/rightward direction (the “Y” direction or an opposite direction to the Y direction) to divide the first accommodation space 201 and the second accommodation space 202.

The accommodation frame 200 may include first rail portions 251 that are provided on opposite sides of the first accommodation space 201 in the leftward/rightward direction, and second rail portions 261 that are provided on opposite sides of the second accommodation space 202 in the leftward/rightward direction thereof.

The accommodation frame 200 may include a first rail support portion 250 that extends in the forward/rearward direction (the “X” direction or an opposite direction to the “X” direction) to support the first rail portions 251, and a second rail support portion 260 that extends in the forward/rearward direction to support the second rail portions 261. The first and second rail support portions 250 and 260 may connect the two side frames 230 that are spaced apart in the forward/rearward directions.

A pair of first rail portions 251 may be provided to define rail grooves that extend in the forward/rearward direction on sides thereof, which face each other. A pair of second rail portions 261 may be provided to define rail grooves that extend in the forward/rearward direction on sides thereof, which face each other.

The rail groove of the first rail portion 251 may be a groove, in which the first shelf 300 is to be slid in the forward/rearward direction thereof. The rail groove of the second rail portion 261 may be a groove, in which the second shelf 400 is to be slid in the forward/rearward direction thereof.

The first shelf 300 may include a first base plate 305 that supports the first electric part 130, and a first base frame 310 that extends along a circumference of the first base plate 305.

The first base plate 305 and the first base frame 310 may be disposed on a lower side of the first electric part 130. The first base plate 305 may be provided in a rectangular shape, and the first base frame 310 may extend along a perimeter of the rectangular shape.

The first shelf 300 may include a plurality of first external support members 320 that extend upwards from the four corners of the first base frame 310, and first internal support members 330 that are provided as a pair that are spaced apart from each other between a pair of first external support members 320 that are spaced apart from each other in leftward/rightward direction, and extend upwards.

The first internal support members 330 may be components for preventing the first electric part 130 from being moved to a front side or a rear side of the first base plate 305.

The first shelf 300 may include a first sliding support portion 340 that connects a pair of first external support members 320 that are spaced apart from each other in the forward/rearward direction, and a first sliding portion 341 which is supported by the first sliding support portion 340 and is coupled to the first rail portion 251. That is, the first sliding portion 341 may be coupled to the first rail portion 251 and may be configured to be slid in the forward/rearward direction thereof.

The second shelf 400 may include a second base plate 405 that supports the second electric part 140, and a second base frame 410 that extends along a circumference of the second base plate 405.

The second base plate 405 and the second base frame 410 may be disposed on a lower side of the second electric part 140. The second base plate 405 may be provided in a rectangular shape, and the second base frame 410 may extend along a perimeter of the rectangular shape.

The second shelf 300 may include a plurality of second external support members 420 that extend upwards from the four corners of the second base frame 410, and second internal support members 430 that are provided as a pair that are spaced apart from each other between a pair of second external support members 420 that are spaced apart from each other in leftward/rightward direction, and extend upwards.

The second internal support member 430 may be a component for preventing the second electric part 140 from being moved to a front side or a rear side of the second base plate 405.

The second shelf 400 may include a second sliding support portion 440 that connects a pair of second external support members 420 that are spaced apart from each other in the forward/rearward direction, and a second sliding portion 441 which is supported by the second sliding support portion 440 and coupled to the second rail portion 261. That is, the second sliding portion 441 may be coupled to the second rail portion 261 and may be configured to be slid in the forward/rearward direction thereof.

By the present structure, the first and second shelves 300 and 400 may be extracted forward from the first and second accommodation spaces 201 and 202, respectively. Meanwhile, the first and second electric parts 130 and 140 may include a plurality of components, and thus may be relatively heavy. As an exemplary embodiment of the present disclosure, the first and second electric parts 130 and 140 may weigh approximately 300 kg.

For the first and second shelves 300 and 400 to be extracted forward while supporting the present weight, the front end portions of the first and second shelves 300 and 400 need to be supported by the floor.

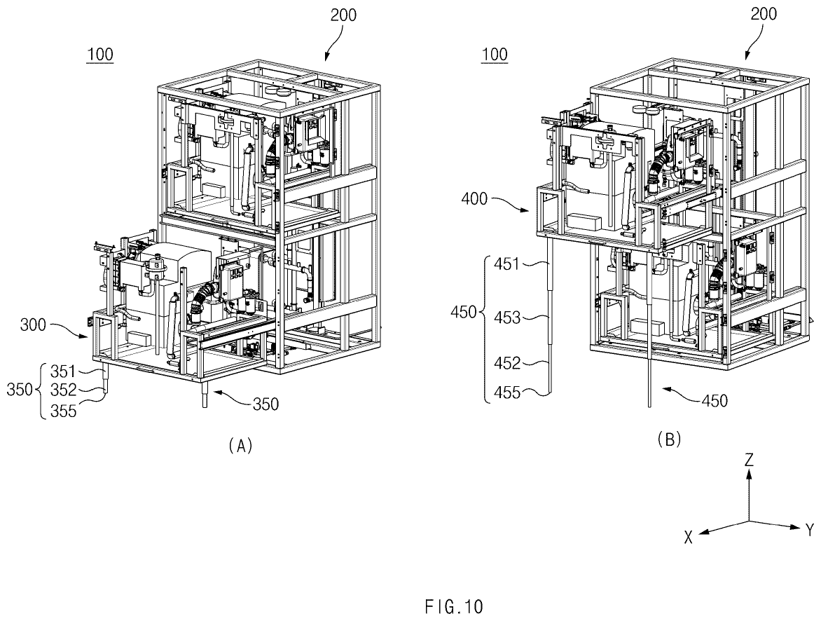

Hereinafter, a structure, in which the first shelf 300 is extracted from the first accommodation space 201, will be described, but for the structure of the second shelf 400, the structure of the first shelf 300 will be used, except for a second shelf leg 450 (see FIG. 10A and FIG. 10B) of the second shelf 400.

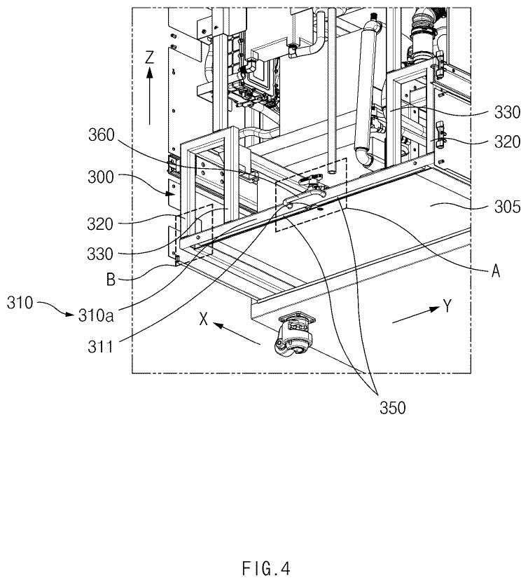

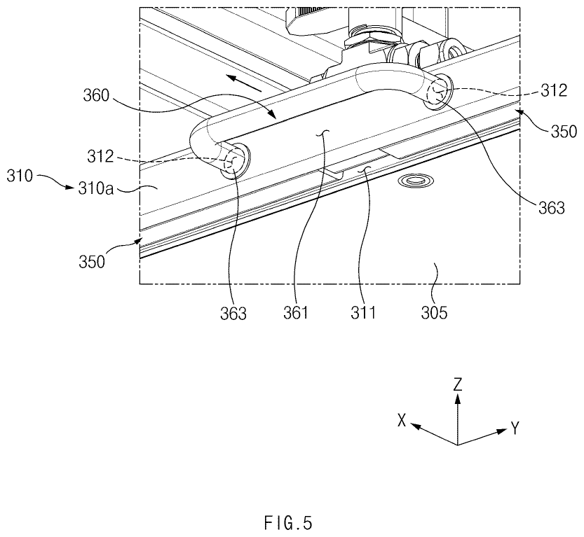

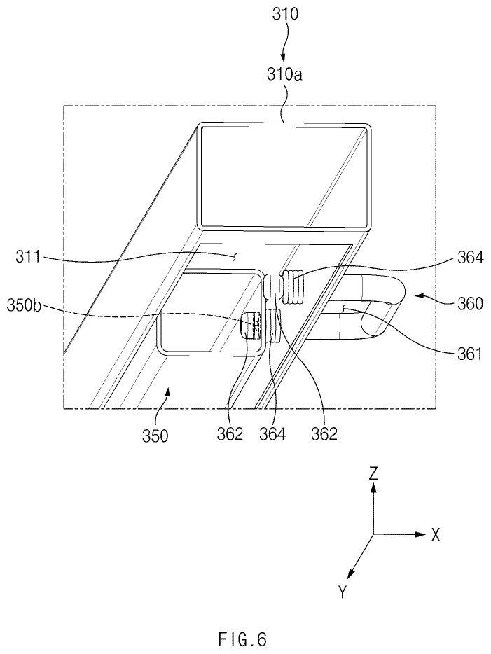

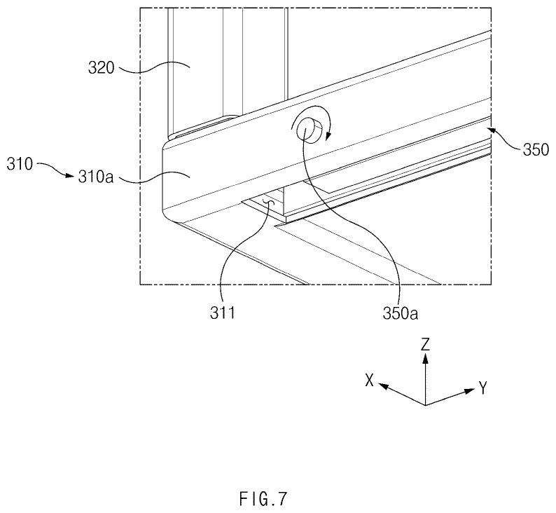

FIG. 4 is a bottom perspective view of the first base frame and surrounding components of the first shelf according to an exemplary embodiment of the present disclosure. FIG. 5 is an enlarged view of portion “A” of FIG. 4. FIG. 6 is an enlarged view of the first shelf leg accommodated in the first leg recess, a guide handle for fixing the first shelf leg, and surrounding components according to an exemplary embodiment of the present disclosure. FIG. 7 is an enlarged view of portion “B” of FIG. 4.

Referring to FIGS. 4 to 7, the first shelf 300 may include a first base frame 310 which is disposed on a lower side of a first sliding portion 341 (see FIG. 2), and a first shelf leg 350 which is mounted on a front end portion 310a of the first base frame 310 to support the front end portion 310a of the first base frame 310.

The first shelf leg 350 may be a component which is disposed on a lower side of the front end portion 310a of the first base frame 310 to support the front end portion 310a of the first base frame 310 when the first shelf 300 is extracted forward from the first accommodation space 201.

The first base frame 310 may include a leg recess 311 which is formed on an inside of the first base frame 310 and is configured to be opened downward to accommodate the first shelf leg 350. The leg recess 311 may be formed on a lower side of the front end portion 310a of the first base frame 310. The leg recess 311 may extend in the leftward/rightward direction, and a pair of first shelf legs 350 may be accommodated in the leg recess 311.

When the first shelf 300 is accommodated in the first accommodation space 201, a pair of first shelf legs 350 may be accommodated in opposite side portions of the leg recess 311 in the leftward/rightward direction, and when the first shelf 300 is extracted forward from the first accommodation space 201, a pair of first shelf legs 350 may be rotated downwardly from the leg recess 311 to protrude to an outside thereof.

The pair of first shelf legs 350 may be hinged to the opposite side portions of the base frame 310, respectively, to be rotated downwardly from the leg recess 311. In other words, the pair of first shelf legs 350 may include hinge shafts 350a that are hinged to opposite end portions of the front end portion 310a of the base frame 310, respectively. Here, the opposite end portions of the front end portion 310a of the base frame 310 may be the opposite end portions of the front end portion 310a of the base frame 310 in the leftward/rightward direction thereof.

Meanwhile, for the first shelf 300 to be smoothly extracted from the first accommodation space 201, the first shelf 300 include the guide handle 360 which is mounted on the front end portion 310a of the first base frame 310. The guide handle 360 may be mounted to be relatively movable in the forward/rearward direction with respect to the front end portion 310a of the first base frame 310.

The guide handle 360 may define a handle space 361 together with the front end portion 310a of the first base frame 310 while a fixing portion 362 formed at the opposite end portions is inserted into the front end portion 310a of the first base frame 310.

The fixing portions 362 of the guide handle 360 may be provided as a pair, and may be inserted into a pair of handle holes 312 that are formed in the front end portion 310a of the first base frame 310, respectively. The pair of handle holes 312 may be formed on an outside of the first base frame 310 and may be spaced apart from each other in leftward/rightward direction thereof.

A size of the largest cross-sectional area of the fixing portion 362 may be configured to be greater than a size of the cross-sectional area of a handle hole 312 to prevent the fixing portion 362 from passing through the handle hole 312. Accordingly, the guide handle 360 may not be separated from the first base frame 310.

Furthermore, the first shelf leg 350 may include a guide hole 350b which is formed on an area that faces the handle hole 312 when the shelf leg 350 is accommodated in the leg recess 311. The fixing portion 362 of the guide handle 360 may be inserted into the guide hole 350b. However, unlike the handle hole 312, the guide hole 350b may be configured so that the fixing portion 362 of the guide handle 360 may be extracted forward from the first shelf leg 350. That is, the cross-sectional area of the guide hole 350b may be configured to be greater than the size of the largest cross-sectional area of the handle hole 312.

When the fixing portion 362 of the guide handle 360 is inserted into the guide hole 350b, the first shelf leg 350 may be supported by the guide handle 360 in an interior of the leg recess 311. Accordingly, a position of the first shelf leg 350 may be fixed.

Unlike this, when the guide handle 360 is moved forward from the front end portion 310a of the first base frame 310, the fixing portion 362 of the guide handle 360 may be extracted forward from the guide hole 350b, and the first shelf leg 350 may be rotated around the hinge shaft 350a.

As described above, the guide handle 360 is not only a configuration for simply extracting the first shelf 300 from the first accommodation space 201, but also a configuration for fixing the first shelf leg 350 in the leg recess 311.

Meanwhile, the guide handle 360 may include an elastic member 364 which is disposed between the fixing portion 362 of the guide handle 360 and the front end portion 310a of the first base frame 310 to apply an elastic force to the fixing portion 362 of the guide handle 360.

In more detail, the guide handle 360 may include a through portion 363 that passes through the handle hole 312 of the first base frame 310 and is connected to the fixing portion 362. A size of a cross-sectional area of the through portion 363 may be smaller than a size of a cross-sectional area of the handle hole 312. Furthermore, a size of the cross-sectional area of the through portion 363 may be smaller than a size of the cross-sectional area of the fixing portion 362.

The elastic member 364 may be formed as a spring that extends to surround the through portion 363. Accordingly, when the guide handle 360 is extracted forward and a force for moving the guide handle 360 forward is no longer applied to the guide handle 360, the guide handle 360 may be moved rearward again by the elastic member 364. That is, the elastic member 364 may be a component which is configured to apply an elastic force to the fixing portion 362 to push the fixing portion 362 backward so that the fixing portion 362 pass through the guide hole 350b and is accommodated in the first shelf leg 350 when there is no external force applied.

Meanwhile, as the guide handle 360 is moved forward, the pair of first shelf legs 350 are configured to be rotated in opposite directions when being rotated downwardly from the leg recess 311.

That is, among the pair of first shelf legs 350, the first shelf leg 350 located on a right side (the “Y” direction) may be rotated counterclockwise from the leg recess 311 with respect to a direction viewed from a front side, and may be moved to an outside of the leg recess 311.

Furthermore, among the pair of first shelf legs 350, the first shelf leg 350 located on a left side (an opposite direction to the “Y” direction) may be rotated clockwise from the leg recess 311 with respect to a direction viewed from a front side, and may be moved to an outside of the leg recess 311.

As described above, when the guide handle 360 is moved forward from the front end portion 310a of the first base frame 310 so that the first shelf 300 is to be extracted forward from the first accommodation space 201, the first shelf leg 350 may be rotated from the leg recess 311 without any separate operation. Accordingly, when the first shelf 300 is extracted forward from the first accommodation space 201, the front end portion 310a of the first base frame 310 is supported by the pair of first shelf legs 350 without any separate operation, and thus, the first electric part 130 may be prevented from coming out to a front side of the first base frame 310.

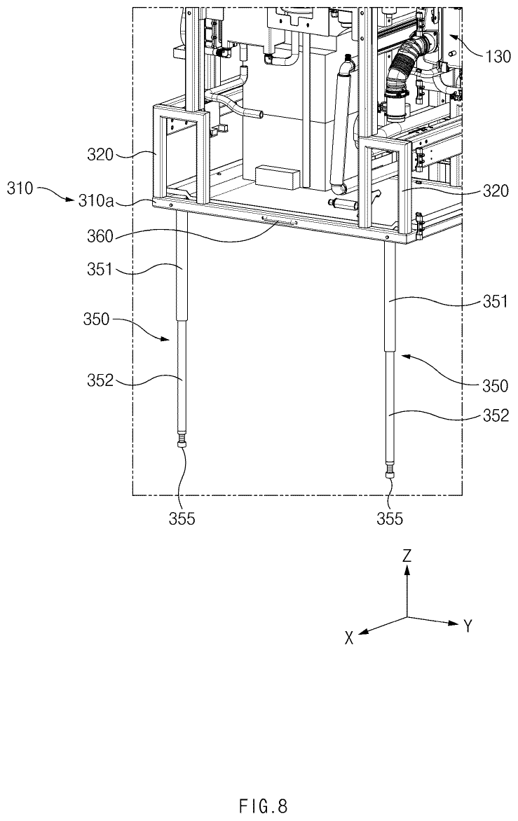

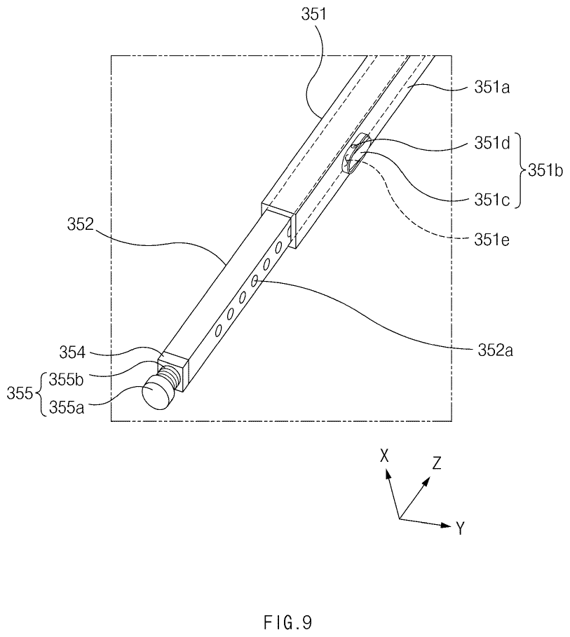

FIG. 8 is a perspective view of the first shelf and the first electric part after the first shelf leg is rotated from the first base frame according to an exemplary embodiment of the present disclosure. FIG. 9 is a bottom perspective view of the first shelf leg according to an exemplary embodiment of the present disclosure.

Referring to FIG. 8 and FIG. 9, the first shelf leg 350 may include an upper leg 351 which is hinged to the front end portion 350a of the first base frame 310, and a lower leg 352 which is configured to be extracted from an interior of the upper leg 351.

When the first shelf leg 350 is accommodated in the leg recess 311, the lower leg 352 may be inserted into an interior of the upper leg 351, and the lower leg 352 may be extracted from the interior of the upper leg 351 when the first shelf leg 350 is rotated from the leg recess 311.

The first shelf leg 350 may include a fixing member 351b which is configured to pass through the upper leg 351 to be fixed while being inserted into the lower leg 352 so that a height, at which the lower leg 352 is extracted from the interior of the upper leg 351 is adjusted.

In more detail, the upper leg 351 may include an external wall 351a that accommodates the lower leg 352 in an interior thereof, and a through-hole 351e which is formed in the external wall 351a, and through which the fixing member 351b passes.

The fixing member 351b may be formed in the external wall 351a of the upper leg 351. The fixing member 351b may include a fixed button 351c which is to pass through the through-hole 351e, and a fixed hinge shaft 351d that passes through a center area of the fixed button 351c in the upward/downward direction thereof. Through the fixed hinge shaft 351d, upper and lower areas of the fixed button 351c may be moved in opposite directions.

Accordingly, when the upper area of the fixed button 351c is pressed, the lower area of the fixed button 351c is extracted from the through-hole 351e, and the lower leg 352 may be extracted from the interior of the upper leg 351. In contrast, when the upper area of the fixed button 351c is not pressed, the lower area of the fixed button 351c may pass through the through-hole 351e to fix the lower leg 352 by the fixed hinge shaft 351d.

The lower leg 352 may include a plurality of fixing holes 352a that are formed in an area that faces an area, in which the through-hole 351eis formed, and through which the fixing member 351b is inserted.

The plurality of fixing holes 352a may be configured to be spaced apart from each other in the upward/downward direction, and a location of the lower leg 352 may be fixed as the lower area of the fixed button 351c of the fixing member 351b is inserted into the fixing hole 352a.

As described above, a length of the first shelf leg 350, which extends downward, may be adjusted depending on whether the fixed button 351c is inserted into any one of the plurality of fixing holes 352a.

Meanwhile, even when the pair of first shelf legs 350 are provided at the same height, there may be a height difference between the two areas of the floor, in which the pair of first shelf legs 350 are supported.

For such cases, the first shelf leg 350 may include a height adjusting leg 355 which is provided at one end portion of the lower leg 352, which is extracted from the upper leg 351, and is configured so that a length thereof may be adjusted in the upward/downward direction so that a length of the first shelf leg 350 in a downward direction may be finely adjusted.

The height adjusting leg 355 may be mounted on lower end portions of the pair of lower legs 352. The height adjusting leg 355 may include a support portion 355a which is to be supported by the floor, and a connecting portion 355b that extends upwards from the support portion 355a. The connecting portion 355b may extend from the support portion 355a toward the lower leg 352. The connecting portion 355b may include a male screw portion.

The lower leg 352 may include a coupling plate 354 which is formed at one end portion of the lower leg 352, which is extracted from the upper leg 351, and into which the height adjusting leg 355 is inserted.

The coupling plate 354 may include a female screw portion, in which a height adjusting hole, into which the connecting portion 355b of the height adjusting leg 355 is inserted, is formed. The female screw portion may be configured to be engaged with the male screw portion of the connecting portion 355b.

By a structure, in which the connecting portion 355b of the height adjusting leg 355 is engaged with the female screw portion of the coupling plate 354, a length of the height adjusting leg 355, which is inserted into the lower leg 352, may be adjusted. Due to the present structure, even when there is a height difference between the two areas of the floor, by which the pair of first shelf legs 350 are supported, the first shelf 300 may be supported more stably even in a state, in which it is extracted forward from the first accommodation space 201 (see FIG. 2).

FIG. 10A and FIG. 10B are perspective views of the fuel cell power generation module, illustrating a state, in which the first shelf is extracted from the first accommodation space, and a state, in which the second shelf is extracted from the second accommodation space, according to an exemplary embodiment of the present disclosure.

Referring to FIGS. 2 and 10A, the first shelf 300 may be extracted forward from the first accommodation space 201 while being supported by the accommodation frame 200. When the first shelf 300 is extracted forward, the lower leg 352 of the first shelf leg 350 may be extracted from the interior of the upper leg 351 of the first shelf leg 350. Accordingly, the first shelf 300 may be extracted from the accommodation frame 200 more stably.

FIGS. 2 and 10B, the second shelf 400 may include a second base frame 410 which is disposed on a lower side of the second sliding portion 441, and a second shelf leg 450 which is mounted on a front end portion of the second base frame 410 to support the second base frame 410.

The second shelf 400 may be extracted forward from the second accommodation space 201 while being supported by the accommodation frame 200. When the second shelf 400 is extracted forward, a front end portion of the second base frame 410 may be supported by the pair of second shelf legs 450.

Unlike the first shelf leg 350, the second shelf leg 450 may further include an upper leg 451, a lower leg 452, and a middle leg 453 which is disposed between the upper leg 451 and the lower leg 452. In more detail, the second shelf leg 450 may include the upper leg 451 which is hinged to the second base frame 410, the middle leg 453 which is configured to be extracted from the inside of the upper leg 451, and the lower leg 452 which is configured to be extracted from the inside of the middle leg 453.

By the structure, in which the middle leg 453 of the second shelf leg 450 is extracted from the upper leg 451 and the lower leg 452 is extracted from the middle leg 453, a maximum length of the second shelf leg 450, which extends downward, may be greater than a maximum length of the first shelf leg 350, which extends downward.

Due to the present structure, the second shelf 400, which is extracted forward from an upper side of the first shelf 300, may be supported more stably by the second shelf leg 450.

Meanwhile, the second shelf leg 450 may include a first fixing member which is configured to pass through the upper leg 451 and be inserted into the middle leg 453, and a second fixing member which is configured to pass through the middle leg 453 and be inserted into the lower leg 452.

For the coupling relationship between the upper leg 451 and the middle leg 453 through the first fixing member, and the structure of the middle leg 453 and lower leg 452 through the second fixing member, the structure of the fixing member 351b of the first shelf leg 350 is used.

Furthermore, the second shelf leg 450 may include a height adjusting leg 455 which is provided at one end portion of the lower leg 452, which is extracted from the middle leg 453, and is configured so that a length thereof may be adjusted in the upward/downward direction thereof. For the structure of the height adjusting leg 455 of the second shelf leg 450, the structure of the height adjusting leg 355 of the second shelf leg 350 is also used.

However, the present disclosure is not limited thereto, and the first shelf leg 350 may also include the upper leg 351 and the lower leg 352, and the middle leg which is disposed between the upper leg 351 and the lower leg 352, and the second shelf leg 450 may also include the upper leg 451 and the lower leg 452. However, it is sufficient as long as a maximum length of the second shelf leg 450, which extends downward, is greater than a maximum length of the first shelf leg 350, which extends downward.

As described above, the fuel cell power generation module 100 may more compactly accommodate the first and second electric parts 130 and 140 (see FIG. 1) that are stacked upward and downward. Furthermore, according to the fuel cell power generation module 100, because the first and second shelves 300 and 400 may be extracted without disconnecting the accommodation frame 200 and the first and second shelves 300 and 400 when the first and second electric parts 130 and 140 need to be replaced or repaired, usability may be improved.

Furthermore, the fuel cell power generation module 100 described above is not provided in an interior of a fuel cell vehicle, but may be used as a component of any device that utilizes a fuel cell as a power source.

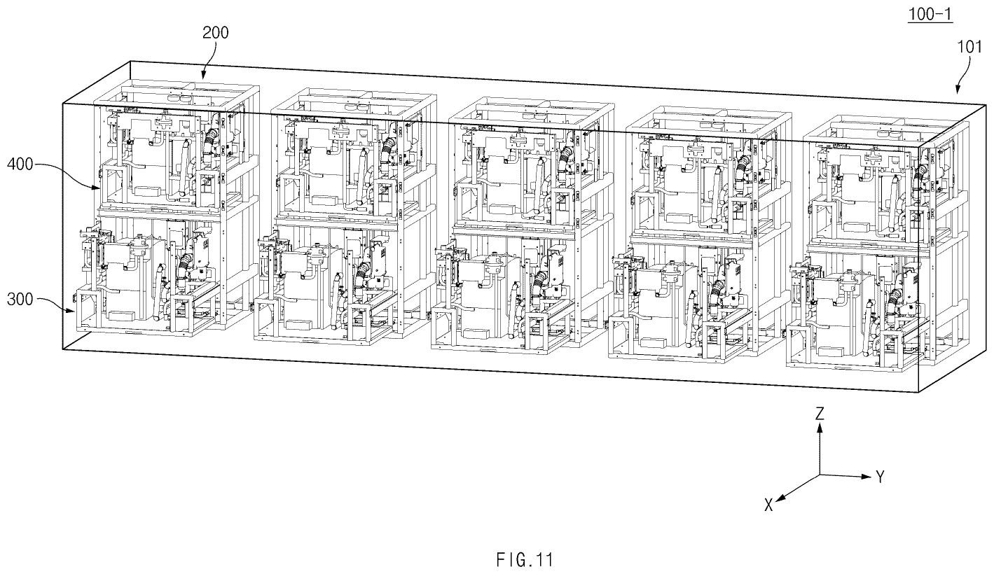

FIG. 11 is a perspective view of a fuel cell power generation module according to another exemplary embodiment of the present disclosure.

Referring to FIG. 11, unlike the fuel cell power generation module 100 illustrated in FIG. 1, the fuel cell power generation module 100-1 may be used as a large-capacity power generation system. The fuel cell power generation module 100-1 may include a plurality of accommodation frames 200 that are disposed in the leftward/rightward direction, and a housing 101 that covers the plurality of accommodation frames 200.

For the fuel cell power generation module 100-1, the structure of the fuel cell power generation module 100 described above is also used, and a front surface of the housing 101 is configured to be open so that each of the first and second shelves 300, 400 may be extracted forward thereof.

This technology allows the shelf to be extracted from the accommodation frame whereby electric parts supported by the shelf may be easily replaced or repaired.

Additionally, the present technology allows the shelf to be supported more stably because the shelf legs are rotated to the lower side of the shelf when the shelf is extracted from the accommodation frame.

Furthermore, in the present technology, the shelf leg unfixed from the shelf by the guide handle so that the shelf leg may support the shelf without any additional movement as the shelf leg is extracted from the accommodation frame.

Furthermore, the present technology allows the shelf to be extracted from the accommodation frame without being limited by the location of the fuel cell power generation module as the length of the shelf leg, which extends to the lower side, is adjusted.

Furthermore, various effects which may be directly or indirectly identified through the present specification may be provided.

The above description is a simple exemplary description of the technical spirits of the present disclosure, and an ordinary person in the art, to which the present disclosure pertains, may make various corrections and modifications without departing from the essential characteristics of the present disclosure.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A fuel cell power generation module comprising:
an accommodation frame defining an accommodation space; and
a shelf configured to support an electric part, and supported by the accommodation frame to be extracted from the accommodation space forward thereof.

2. The fuel cell power generation module of claim 1,
wherein the accommodation space includes a first accommodation space, and the shelf includes a first shelf configured to support the electric part including a fuel cell,
wherein the accommodation frame includes rail portions provided on opposite sides of the first accommodation space in a transverse direction of the fuel cell power generation module, and
wherein the first shelf includes sliding portions coupled to the rail portions, and configured to be slid in a first direction.

3. The fuel cell power generation module of claim 2, wherein the first shelf includes:
a base frame disposed on a lower side of the sliding portions; and
a shelf leg mounted on a front end portion of the base frame to support a front end portion of the base frame.

4. The fuel cell power generation module of claim 3,
wherein the base frame includes a leg recess formed on an inside of the base frame, and configured to be opened downward to accommodate the shelf leg, and
wherein the shelf leg is hinged to one side of the base frame to be rotated from the leg recess downward.

5. The fuel cell power generation module of claim 4, wherein a pair of shelf legs are provided in opposite side portions of the base frame in the transverse direction, and are configured to be rotated in opposite directions when being rotated from the leg recess downward.

6. The fuel cell power generation module of claim 5, wherein the pair of shelf legs are hinged to opposite end portions of the base frame in the transverse direction.

7. The fuel cell power generation module of claim 4, wherein the shelf leg includes:
an upper leg hinged to the base frame; and
a lower leg configured to be extracted from an interior of the upper leg.

8. The fuel cell power generation module of claim 7,
wherein the shelf leg further includes a fixing member configured to pass through the upper leg to be inserted into the lower leg,
wherein the upper leg includes an external wall accommodating the lower leg in an interior thereof, and a through-hole formed in the external wall and through which the fixing member passes, and
wherein the lower leg includes a fixing hole, into which the fixing member is inserted.

9. The fuel cell power generation module of claim 7, wherein the shelf leg further includes a height adjusting leg provided at one end portion of the lower leg, which is extracted from the upper leg, and configured so that a length thereof is adjustable in an second direction.

10. The fuel cell power generation module of claim 9,
wherein the lower leg includes a coupling plate formed at the one end portion of the lower leg and including a female screw portion including a height adjusting hole, into which the height adjusting leg is inserted, and
wherein the height adjusting leg includes:
a support portion for being supported by a floor; and
a connecting portion extending from the support portion toward the lower leg to be inserted into the height adjusting hole, and including a male screw portion configured to be engaged with the female screw portion.

11. The fuel cell power generation module of claim 3, wherein the first shelf further includes:
a guide handle mounted on the front end portion of the base frame to be movable in the first direction.

12. The fuel cell power generation module of claim 11, wherein the base frame includes a leg recess formed on an inside of the base frame, and configured to be opened downward to accommodate the shelf leg, and a handle hole formed on an outside of the base frame, and into which the guide handle is inserted.

13. The fuel cell power generation module of claim 12,
wherein the shelf leg includes a guide hole formed on an area facing the guide handle when the shelf leg is accommodated in the leg recess,
wherein the guide handle includes a fixing portion configured to be inserted into the handle hole and the guide hole, and
wherein the fixing portion of the guide handle is extracted forward from the guide hole when the guide handle is moved forward from the front end portion of the base frame.

14. The fuel cell power generation module of claim 13, wherein the guide handle further includes an elastic member disposed between the fixing portion of the guide handle and the front end portion of the base frame to apply an elastic force to the fixing portion of the guide handle.

15. The fuel cell power generation module of claim 14,
wherein the guide handle further includes a through portion connected to the fixing portion of the guide handle, and passing through the handle hole, and
wherein the elastic member extends to surround the through portion.

16. The fuel cell power generation module of claim 1,
wherein the accommodation space includes a second accommodation space, and the shelf includes a second shelf,
wherein the accommodation frame further defines the second accommodation space located on an upper side of the first accommodation space, and
wherein the second shelf is supported by the accommodation frame to be extracted from the second accommodation space.

17. The fuel cell power generation module of claim 16,
wherein the accommodation frame includes rail portions provided on opposite sides of the second accommodation space in a transverse direction of fuel cell power generation module, and
wherein the second shelf includes a sliding portion coupled to the rail portions and configured to be slid in a first direction.

18. The fuel cell power generation module of claim 17,
wherein the second shelf includes a base frame disposed on a lower side of the sliding portion, and a shelf leg mounted on a front end portion of the base frame to support the base frame, and
wherein the shelf leg of the second shelf includes at least two legs telescopically engaged to each other.

19. The fuel cell power generation module of claim 18, wherein the at least two legs includes:
an upper leg hinged to the base frame;
a middle leg configured to be extracted from an interior of the upper leg; and
a lower leg configured to be extracted from an interior of the middle leg.

20. The fuel cell power generation module of claim 18,
wherein the first shelf includes a base frame, and a shelf leg mounted on the front end portion of the base frame to support the base frame,
wherein the shelf leg of the first shelf includes:
an upper leg hinged to the base frame, and
a lower leg configured to be extracted from an interior of the upper leg.
